(19) United States
(12) Patent Application Publication
(10) Pub. No.: US 2018/0112088 A1
(43) Pub. Date: Apr. 26, 2018

(54) WATER-SOLUBLE POUCH FOR COLORING A WATER-BASED COATING

(71) Applicant: Steven Atkinson, Myrtle Beach, SC (US)

(72) Inventor: Steven Atkinson, Myrtle Beach, SC (US)

(21) Appl. No.: 15/790,659

(22) Filed: Oct. 23, 2017

Related U.S. Application Data
(60) Provisional application No. 62/411,253, filed on Oct. 21, 2016.

(51) Int. Cl. C09D 7/14; B65D 65/46; B65D 75/32; B65D 75/42; C09D 113/02

(52) U.S. Cl. CPC C09D 7/14; B65D 65/46; C09D 113/02; B65D 75/42; B65D 75/32

(57) ABSTRACT

A water-soluble pouch for coloring a water-based coating, such as a paint or a stucco, is disclosed. The water-soluble pouch includes first and second sheets of water-soluble material that are plastically deformed and at least partially joined together such that interior surfaces of the first and second sheets cooperate to define at least one interior chamber. The first and second sheets are at least partially joined together by way of a bonding process. One or more pigments are contained within the at least one interior chamber. The water-soluble pouch is configured to dissolve and release the one or more pigments into the water-based coating when mixed with the water-based coating for at least a predetermined period of time. A method for coloring a water-based coating is also disclosed.

### CROSS-REFERENCE TO RELATED APPLICATION

This application claims the benefit of U.S. Provisional Patent Application Ser. No. 62/411,253, filed Oct. 21, 2016, the entire contents of which are hereby incorporated by reference.

### TECHNICAL FIELD

The present disclosure generally relates to water-soluble pouches and, more particularly, to water-soluble pouches containing one or more pigments for coloring water-based coatings.

### BACKGROUND

Water-based coatings, which may include various paints, stuccos, sealers and other products, are commonly used in home improvement, construction and in several other industries for a variety of purposes. For example, water-based coatings may be used for interior or exterior aesthetic purposes, such as decorating or coloring walls, as well as for sealing, weatherproofing or otherwise protecting surfaces to which the water-based coatings are applied. Additionally, the use of water-based coatings is widely considered to be advantageous in terms of cleanup, as soap and/or water is generally all that is needed for sufficiently cleaning various matter such as supplies (e.g. drop cloths, brushes, rollers, sprayers, trowels or other accessories), surrounding areas where the water-based coatings are applied, body parts (e.g. hands) of persons applying the water-based coatings, articles of clothing or other objects which may require cleaning after working with and applying the water-based coatings. Furthermore, water-based coatings are considered to be less toxic and more environmentally friendly than other types of coatings, such as solvent-based coatings, otherwise known as “oil-based” coatings.

Several water-based coatings are available in a wide variety of predetermined colors advertised or otherwise offered by various manufacturers. Many hardware stores, home improvement stores and paint stores have the capability to produce a wide variety of predetermined colors or even custom colors for water-based coatings, which may be formulated by way of manual or computerized coloring equipment. As such, the process of adding a predetermined or custom color (commonly referred to as “coloring”, “tinting”, “pigmenting”, “dyeing”, etc.) to a water-based coating, such as a paint or a stucco, is usually performed at a hardware store, a home improvement store or a paint store. The coloring process is often lengthy, and involves first selecting an appropriate base (typically available in white, pastel, light, medium, deep or clear base and in a variety of sheens and/or textures). The appropriate base is often selected by considering such factors as the desired sheen and/or texture and the shade of the desired final color of the water-based coating. Once the appropriate base is selected, a standard-sized container holding a predetermined amount of the base is typically unsealed and opened (e.g. by removing a lid) to allow one or more pigments (also commonly referred to as “colorants”, “tints”, “dyes”, etc.) to be added into the container. The container is then typically closed and resealed so as to be capable of undergoing a vigorous mixing or “shaking” process carried out by a shaker machine. Once the container has been shaken by the shaker machine for a given period of time, it is typically unsealed and opened once again to permit a visual inspection of the mixed/colored water-based coating. Typically, a main objective of the visual inspection is to ensure that the one or more pigments have been properly mixed with the base and that a desired final color and/or color consistency of the water-based coating has been achieved. Additionally, a small wet sample of the mixed/colored water-based coating is usually applied to a lid of the container and heat-dried for the purposes of displaying and/or inspecting the final color of the water-based coating in a dry state. After completing the visual inspection of the mixed/colored water-based coating, the container is then typically closed and resealed yet again so as to be capable of being transported out of the store and to a desired location (e.g. a job site, a residential home or building, a commercial building, etc.).

The aforementioned process of coloring water-based coatings, particularly at hardware stores, home improvement stores or paint stores, poses several limitations and challenges to both the stores and the customers obtaining the water-based coatings. As discussed, the aforementioned process of coloring water-based coatings is often lengthy and typically relies upon various tasks or steps being completed by one or more of manual or computerized coloring equipment, shaker machines and manual labor. Depending on the size or business volume of the particular store coloring and selling the water-based coatings, a full-time staff including several employees may be needed just to keep up with customer demand, leading to increased overhead and higher cumulative labor costs, especially when factoring in employee benefits. Additionally, customers may be kept waiting for extended periods of time to receive their orders of colored water-based coatings, especially during peak times, which may include mornings or weekends. Such customers may include non-commercial “do-it-yourselfers” working on home or weekend projects, but may also often include professional contractors. When professional contractors are kept waiting for their orders, workers may not be able to start or finish a job on time, which often leads to further inefficiency and/or money loss for the contractor.

In addition to the aforementioned limitations and challenges, issues involving color inaccuracy or inconsistency may arise when coloring water-based coatings. As a result of human error, improper calibration or other factors, manual and/or computerized coloring equipment, located within the same store or across a variety of stores, may formulate colors inaccurately or inconsistently, which is problematic for a variety of reasons. For example, if a larger amount of water-based coating is initially obtained and applied during a job or project, a smaller amount of water-based coating of the same color may be needed at a later date to perform necessary touch-up work. When the smaller amount of water-based coating is colored at a later date, inaccuracy or inconsistency in coloring will result in the touch-up work being aesthetically unpleasant, as the previously-applied water-based coating and the newly-applied water-based coating will usually not properly match and blend. As another example, professional contractors working on large-scale projects such as commercial buildings or entire subdivisions typically obtain several batches of colored water-based coatings, often transported in five-gallon containers delivered on pallets. Inaccuracy or inconsistency in coloring among the several batches may result in highly-visible areas or objects, such as large exterior or interior walls, being inaccurately or inconsistently colored. Such inaccurate or inconsistent coloring, particularly on such large-scale projects as subdivisions, may be considered catastrophic and result in severe time and/or money loss for both the professional contractor and the store or facility which colored the batches of water-based coatings, since several replacement batches of colored water-based coatings may need to be obtained and applied again.

In addition to the aforementioned limitations and challenges, customers often overestimate or underestimate the appropriate amount of colored water-based coating needed to complete a particular job, depending on the circumstance. This often results in some amount of water-based coating being unused and going to waste, or forces another trip to the store to obtain more of the colored water-based coating.

With the aforementioned limitations and challenges in mind, there is a continuing unaddressed need for the ability to color water-based coatings, in small or large quantities, in a convenient, economical, accurate, consistent and expeditious manner, and at a variety of flexible locations.

### SUMMARY

The above-identified need is met with the present disclosure. One aspect of this disclosure is directed to a water-soluble pouch for coloring a water-based coating. The water-soluble pouch includes a first sheet of water-soluble material having an interior surface and an opposing exterior surface, and a second sheet of water soluble material having an interior surface and an opposing exterior surface. The first and second sheets are plastically deformed and at least partially joined together such that the interior surfaces of the first and second sheets cooperate to define at least one interior chamber. One or more pigments are contained within the at least one interior chamber. The one or more pigments may be selected from a group of pigments. The group of pigments may include a primary blue pigment, a primary red pigment, a primary yellow pigment, a black pigment, a white pigment and combinations thereof. The first and second sheets are at least partially joined together by way of a bonding process. The water-soluble pouch is configured to dissolve and release the one or more pigments into the water-based coating when mixed with the water-based coating for at least a predetermined period of time.

Another aspect of this disclosure is directed to a method of coloring a water-based coating. The method includes the steps of providing a container holding a predetermined amount of water-based coating, and providing a predetermined quantity of water-soluble pouches. The predetermined quantity of water-soluble pouches is determined based on the predetermined amount of water-based coating held in the container. Each water-soluble pouch of the predetermined quantity of water-soluble pouches includes a first sheet of water-soluble material having an interior surface and an opposing exterior surface, and a second sheet of water soluble material having an interior surface and an opposing exterior surface. The first and second sheets are plastically deformed and at least partially joined together such that the interior surfaces of the first and second sheets cooperate to define at least one interior chamber. One or more pigments are contained within the at least one interior chamber. The one or more pigments may be selected from a group of pigments. The group of pigments may include a primary blue pigment, a primary red pigment, a primary yellow pigment, a black pigment, a white pigment and combinations thereof. The first and second sheets are at least partially joined together by way of a bonding process. The method further includes the steps of providing a mixing device, inserting the predetermined quantity of water-soluble pouches into the predetermined amount of water-based coating held in the container, and operating the mixing device to mix the predetermined quantity of water-soluble pouches with the predetermined amount of water-based coating held in the container for at least a predetermined period of time.

Another aspect of this disclosure is directed to a method of coloring a latex paint. The method includes the steps of providing a container holding a predetermined amount of latex paint, and providing a predetermined quantity of water-soluble pouches. The predetermined quantity of water-soluble pouches is determined based on the predetermined amount of latex paint held in the container. Each water-soluble pouch of the predetermined quantity of water-soluble pouches includes a first sheet of water-soluble material having an interior surface and an opposing exterior surface, and a second sheet of water soluble material having an interior surface and an opposing exterior surface. The first and second sheets are plastically deformed and at least partially joined together such that the interior surfaces of the first and second sheets cooperate to define at least one interior chamber. One or more pigments are contained within the at least one interior chamber. The one or more pigments may be selected from a group of pigments. The group of pigments may include a primary blue pigment, a primary red pigment, a primary yellow pigment, a black pigment, a white pigment and combinations thereof. The first and second sheets are at least partially joined together by way of a bonding process. The method further includes the steps of providing a mixing device, inserting the predetermined quantity of water-soluble pouches into the predetermined amount of latex paint held in the container, and operating the mixing device to mix the predetermined quantity of water-soluble pouches with the predetermined amount of latex paint held in the container for at least a predetermined period of time.

### BRIEF DESCRIPTION OF THE DRAWINGS

One or more embodiments of the present disclosure are pointed out with particularity in the appended claims. However, other features of the one or more embodiments will become more apparent and will be best understood by referring to the following detailed description in conjunction with the accompanying drawings, wherein:

FIG. 1 is a perspective view of a water-soluble pouch used for coloring a water-based coating;

FIG. 2 is a cross-sectional view of an interior chamber of the water-soluble pouch shown in FIG. 1; and

FIG. 3 is a cross-sectional view of a container holding a predetermined amount of water-based coating, the predetermined amount of water-based coating being mixed with the predetermined quantity of water-soluble pouches by a mixing device.

### DETAILED DESCRIPTION

As required, one or more detailed embodiments of the present disclosure are disclosed herein, however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Referring to FIG. 1, an exemplary embodiment of a water-soluble pouch 10 for coloring a water-based coating is shown. The water-soluble pouch 10 may color any water-based protective coating, including sealers, water-based decorative coating or derivatives thereof. As non-limiting examples, the water-soluble pouch 10 may color a water-based protective or decorative coating configured to be applied to a surface with at least one of a roller, a brush, a sprayer and a trowel. As further non-limiting examples, the water-based coating may comprise a paint, such as a latex or acrylic latex paint or any other water-based paint. As further non-limiting examples, the water-based coating may comprise a stucco, such as an acrylic stucco, an elastomeric stucco, a synthetic stucco or any other water-based stucco. In any case, the water-based coating, before being colored by at least one water-soluble pouch 10, is typically available in a white, pastel, light, medium, deep or clear base and in a variety of sheens and/or textures.

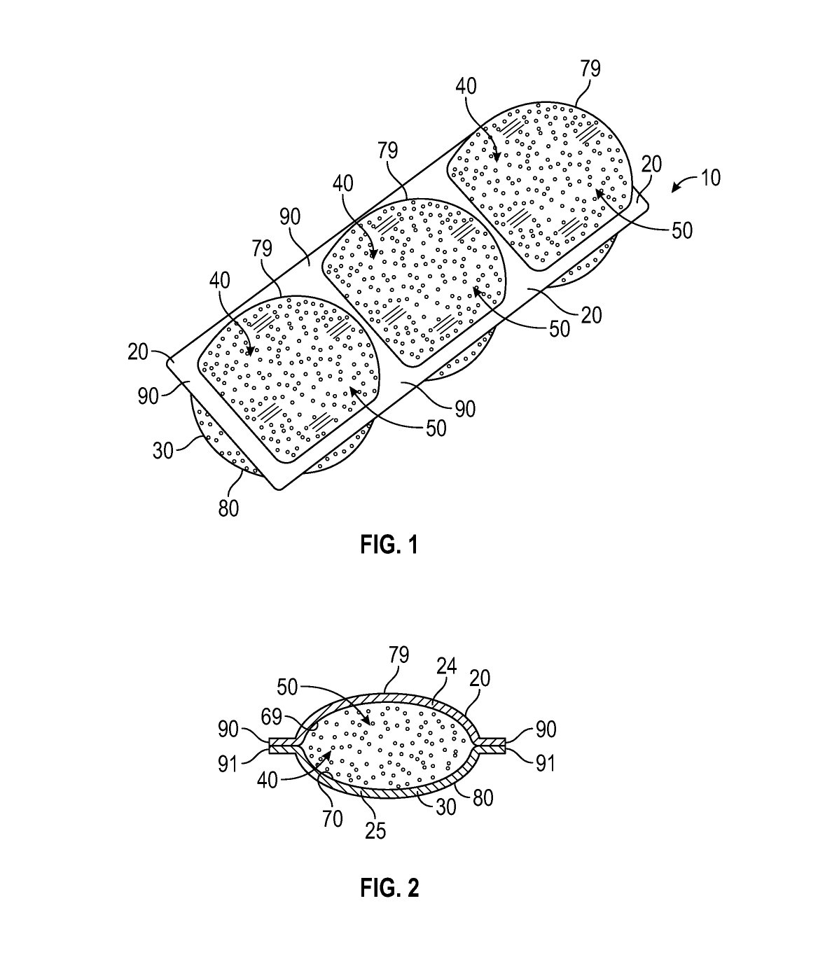

Referring to FIGS. 1 and 2, the water-soluble pouch 10 may comprise a first sheet 20 having an interior surface 69 and an opposing exterior surface 79, and a second sheet 30 having an interior surface 70 and an opposing exterior surface 80. The first and second sheets 20, 30 may be comprised of respective first and second water-soluble materials. The first and second water-soluble materials may be any suitable water-soluble material. As a non-limiting example, each of the first and second water-soluble materials may comprise a water-soluble polymer. As further non-limiting examples, each of the first and second water-soluble materials may comprise a material selected from a group consisting of polyvinyl alcohol, polyvinylpyrrolidone, polyethylene oxide, polyvinyl acetate, polyacrylamide, polysaccharide and cellulose ether.

The first and second sheets 20, 30 may be plastically deformed along respective portions 24, 25 of the first and second sheets 20, 30, and may be at least partially joined together such that the interior surfaces 69, 70 of the first and second sheets 20, 30 cooperate to define at least one interior chamber 40. The first and second sheets 20, 30 may be plastically deformed by way of a thermoforming process, although any suitable process for plastically deforming the portions 24, 25 of the first and second sheets 20, 30 may be used. The at least one interior chamber 40 may comprise a single interior chamber 40 or two or more separate interior chambers 40, such as shown in FIG. 1. In the case where the at least one interior chamber 40 comprises two or more separate interior chambers 40, it should be appreciated that the respective two or more separate interior chambers 40 may have interior volumes which are substantially equal relative to one another, or conversely, the respective two or more separate interior chambers 40 may have interior volumes which vary relative to one another. As non-limiting examples, the interior volume of the at least one interior chamber 40 may be measured in liters, milliliters, cubic centimeters, pints, fluid ounces, or other suitable units to measure volume. The first and second sheets 20, 30 may be at least partially joined together by way of outer peripheral edges 90, 91 of the respective first and second sheets 20, 30 being joined together and sealed. The outer peripheral edges 90, 91 of the respective first and second sheets 20, 30 may be joined together and sealed by way of a bonding process, which may take place simultaneously with or immediately following the thermoforming process. Any suitable bonding process for joining together and sealing the outer peripheral edges 90, 91 of the respective first and second sheets 20, 30 may be used. As non-limiting examples, the bonding process may be selected from a group consisting of heat sealing, solvent welding, wet sealing and combinations thereof.

As shown in FIGS. 1 and 2, one or more pigments 50 may be contained within the at least one interior chamber 40, and therefore, one or more pigments 50 may be contained within a single interior chamber 40 or two or more separate interior chambers 40. The water-soluble pouch 10 is configured to dissolve and release the one or more pigments 50 into a water-based coating when mixed with the water-based coating for at least a predetermined period of time. As disclosed above, the first and second sheets 20, 30 may be plastically deformed along respective portions 24, 25 of the first and second sheets 20, 30, such as by way of a thermoforming process. As a non-limiting example, one or more pigments 50 may be dispensed into at least one cavity defined by at least one of the respective portions 24, 25, during the thermoforming process, which may utilize a heated mold and further comprise a vacuum-forming process. Once the one or more pigments 50 are dispensed into at least one cavity defined by at least one of the respective portions 24, 25 of the plastically-deformed first and second sheets 20, 30, the first and second sheets 20, 30 may be at least partially joined together such that the interior surfaces 69, 70 of the first and second sheets 20, 30 cooperate to define the at least one interior chamber 40 with the one or more pigments 50 contained in the at least one interior chamber 40. The outer peripheral edges 90, 91 of the respective first and second sheets 20, 30 may be joined together and sealed by way of a bonding process, as previously described above, which may take place simultaneously with or immediately following the thermoforming process, so as to sufficiently seal the one or more pigments 50 within the at least one interior chamber 40.

The one or more pigments 50 may be any suitable pigment or pigments capable of coloring water-based coatings, such as pigments produced and/or used by manufacturers of water-based coatings, hardware stores, home improvement stores or paint stores. The one or more pigments 50 may be in the form of a powder, a liquid or a powder and liquid combination. The one or more pigments 50 may be available in a wide variety of predetermined standard or custom colors, which may be produced by employing traditional color theory. In traditional color theory, typically relied upon when using one or more pigments to color water-based coatings, colors of one or more pigments may be derived from a color group including the three primary colors of blue, red and yellow, along with black, white and various combinations thereof. As non-limiting examples, the primary colors of blue, red and yellow may be combined to produce the secondary colors of green, orange and purple. Furthermore, tertiary colors of yellow-orange, red-orange, red-purple, blue-purple, blue-green and yellow-green may be produced by combining primary and secondary colors, and so on. Therefore, a color group including the three primary colors of blue, red and yellow, along with black, white and various combinations thereof may selectively produce any desired color possible within the boundaries of traditional color theory. As non-limiting examples, such desired colors may include numerous shades of black, blue, brown, gray, green, orange, pink, purple, red, white and yellow. Therefore, based on at least traditional color theory and the vast number of colors which may be derived from it, the one or more pigments 50 contained within the at least one interior chamber 40 of the water-soluble pouch 10 may be selected from a group consisting of a primary blue pigment, a primary red pigment, a primary yellow pigment, a black pigment, a white pigment and various combinations thereof.

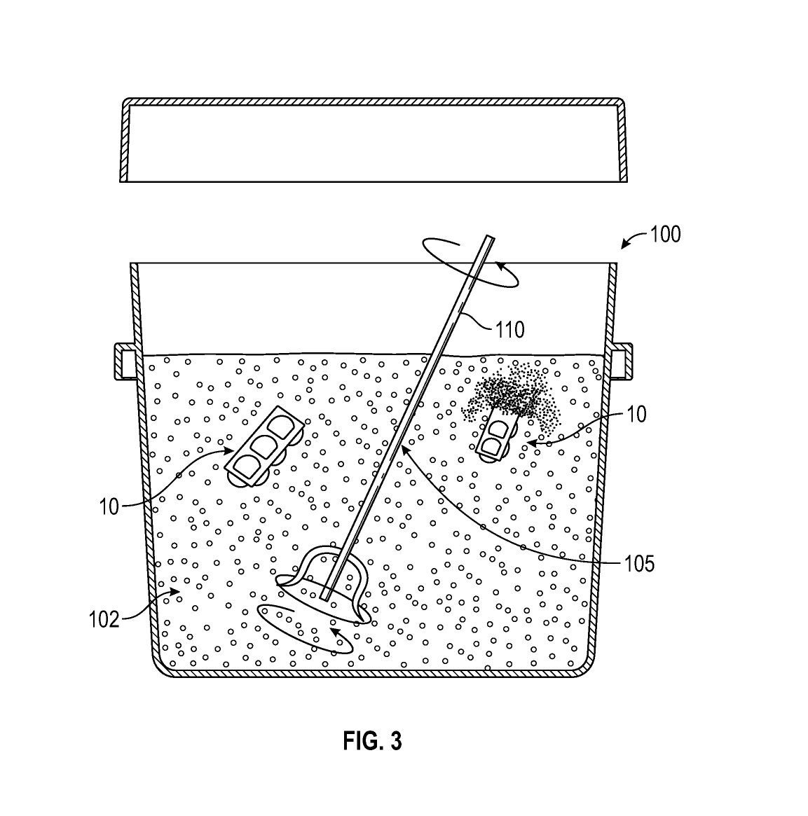

Referring now to FIG. 3, a method of coloring a water-based coating 102 will be described in detail. The method may comprise the step of providing a container 100 holding a predetermined amount of water-based coating 102. It may be appreciated that the container 100 may be of any standard or custom size, categorized in both English and Metric units. Additionally, it may be further appreciated that the container 100 need not be provided at a store, but at a variety of flexible locations, such as at a home or a commercial job site. As non-limiting examples, the container 100 may hold one-pint, one-quart, one-gallon or five-gallons of water-based coating 102. The water-based coating 102 may include sealers, water-based decorative coating or derivatives thereof. As non-limiting examples, the water-based coating 102 may be a water-based protective or decorative coating configured to be applied to a surface with at least one of a roller, a brush, a sprayer and a trowel. As further non-limiting examples, the water-based coating 102 may comprise a paint, such as a latex or acrylic latex paint or any other water-based paint. As further non-limiting examples, the water-based coating 102 may comprise a stucco, such as an acrylic stucco, an elastomeric stucco, a synthetic stucco or any other water-based stucco. In any case, the water-based coating 102, before being colored, is typically available in a white, pastel, light, medium, deep or clear base and in a variety of sheens and/or textures

Additionally, the method may further comprise the step of providing a predetermined quantity of water-soluble pouches 10. Each water-soluble pouch 10 of the predetermined quantity of water-soluble pouches 10 is as previously described herein, and therefore will not be further explained in detail. The predetermined quantity of water-soluble pouches 10 may be determined based on the predetermined amount of water-based coating 102 held in the container 100. As a non-limiting example, based on specific recommendations from the manufacturer of the water-soluble pouch 10 and in conjunction with other factors such as the desired color of the water-based coating 102, the selected base of the water-based coating 102 and the predetermined amount of water-based coating 102 held in the container 100, a quantity of the water-soluble pouches 10 needed to be mixed with the predetermined amount of water-based coating 102 to achieve the desired color may be calculated or otherwise determined. This is particularly advantageous since larger or smaller amounts of water-based coating 102 may be colored as needed, which may increase efficiency and reduce waste of unused water-based coating 102 or eliminate the need to return to a store to obtain more colored water-based coating.

Additionally, the method may further comprise the step of providing a mixing device 105. As a non-limiting example, the mixing device 105 may be an attachment including a rotatable shaft 110 configured to attach with a powered mixer (not shown). The powered mixer may be any suitable manually-powered, electrically-powered or pneumatically-powered device capable of mixing the predetermined number of water-soluble pouches 10 together with the predetermined amount of water-based coating 102. Additionally, the method may further comprise the step of inserting the predetermined quantity of water-soluble pouches 10 into the predetermined amount of water-based coating 102 held in the container 100. Finally, the method may further comprise the step of operating, or otherwise causing rotation of the mixing device 105 to mix the predetermined quantity of water-soluble pouches 10 with the predetermined amount of water-based coating 102 held in the container 100 for at least a predetermined period of time. The predetermined period of mixing time may be recommended by the manufacturer, or alternatively, may be the time needed for the predetermined quantity of water-soluble pouches 10 to fully dissolve and release the one or more pigments 50, such that the desired color and/or color consistency of the colored water-based coating 102 held in the container 100 is achieved.

While one or more exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It should be further understood that certain steps could be performed simultaneously, that other steps could be added, or that certain steps described herein could be omitted. In other words, the descriptions of processes described above are provided for the purpose of illustrating certain embodiments, and should in no way be construed so as to limit the claims.

As used in this specification and claims, the terms “for example”, “for instance”, “such as”, and “like”, and the verbs “comprising”, “having”, “including”, and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

Having thus described the disclosure, what is claimed is:

1. A water-soluble pouch for coloring a water-based coating, the water-soluble pouch comprising:
a first sheet having an interior surface and an opposing exterior surface, the first sheet comprised of a first water-soluble material;
a second sheet having an interior surface and an opposing exterior surface, the second sheet comprised of a second water-soluble material, the first and second sheets being plastically deformed and at least partially joined together such that the interior surfaces of the first and second sheets cooperate to define at least one interior chamber; and
one or more pigments contained within the at least one interior chamber;
wherein:
the one or more pigments are selected from a group consisting of a primary blue pigment, a primary red pigment, a primary yellow pigment, a black pigment, a white pigment and combinations thereof,
the first and second sheets are at least partially joined together by way of a bonding process, and
the water-soluble pouch is configured to dissolve and release the one or more pigments into the water-based coating when mixed with the water-based coating for at least a predetermined period of time.

2. The water-soluble pouch according to claim 1, wherein the first and second sheets are plastically deformed by way of a thermoforming process.

3. The water-soluble pouch according to claim 1, wherein the bonding process is selected from a group consisting of heat sealing, solvent welding, wet sealing and combinations thereof.

4. The water-soluble pouch according to claim 1, wherein the at least one interior chamber comprises two or more separate interior chambers, and each of the two or more separate interior chambers contain the one or more pigments selected from the group of pigments.

5. The water-soluble pouch according to claim 4, wherein the two or more separate interior chambers have respective interior volumes which are substantially equal relative to one another.

6. The water-soluble pouch according to claim 4, wherein the two or more separate interior chambers have respective interior volumes which vary relative to one another.

7. The water-soluble pouch according to claim 1, wherein the first and second water-soluble materials each comprise a water-soluble polymer.

8. The water-soluble pouch according to claim 1, wherein the first and second water-soluble materials each comprise a material selected from a group consisting of polyvinyl alcohol, polyvinylpyrrolidone, polyethylene oxide, polyvinyl acetate, polyacrylamide, polysaccharide and cellulose ether.

9. The water-soluble pouch according to claim 1, wherein the one or more pigments are in the form of a powder.

10. The water-soluble pouch according to claim 1, wherein the one or more pigments are in the form of a liquid.

11. The water-soluble pouch according to claim 1, wherein the one or more pigments are in the form of a powder and liquid combination.

12. The water-soluble pouch according to claim 1, wherein the water-based coating is a paint.

13. The water-soluble pouch according to claim 12, wherein the paint is a latex paint.

14. The water-soluble pouch according to claim 13, wherein the latex paint is an acrylic latex paint.

15. The water-soluble pouch according to claim 1, wherein the water-based coating is a stucco.

16. The water-soluble pouch according to claim 15, wherein the stucco is one of an acrylic stucco, an elastomeric stucco and a synthetic stucco.

17. The water-soluble pouch according to claim 1, wherein the water-based coating is a protective or decorative coating configured to be applied to a surface with at least one of a roller, a brush, a sprayer and a trowel.

18. A method of coloring a water-based coating, the method comprising the steps of:
(A) providing a container holding a predetermined amount of water-based coating;
(B) providing a predetermined quantity of water-soluble pouches, wherein the predetermined quantity of water-soluble pouches is determined based on the predetermined amount of water-based coating held in the container, each water-soluble pouch of the predetermined quantity of water-soluble pouches comprising:
a first sheet having an interior surface and an opposing exterior surface, the first sheet comprised of a first water-soluble material;
a second sheet having an interior surface and an opposing exterior surface, the second sheet comprised of a second water-soluble material, the first and second sheets being plastically deformed and at least partially joined together such that the interior surfaces of the first and second sheets cooperate to define at least one interior chamber; and
one or more pigments contained within the at least one interior chamber;
wherein:
the one or more pigments are selected from a group consisting of a primary blue pigment, a primary red pigment, a primary yellow pigment, a black pigment, a white pigment and combinations thereof, and
the first and second sheets are at least partially joined together by way of a bonding process;
the method further comprising the steps of:
(C) providing a mixing device;
(D) inserting the predetermined quantity of water-soluble pouches into the predetermined amount of water-based coating held in the container; and
(E) operating the mixing device to mix the predetermined quantity of water-soluble pouches with the predetermined amount of water-based coating held in the container for at least a predetermined period of time.

19. The method of coloring a water-based coating according to claim 18, wherein the predetermined amount of water-based coating is a predetermined amount of protective or decorative coating configured to be applied to a surface with at least one of a roller, a brush, a sprayer and a trowel.

20. A method of coloring a latex paint, the method comprising the steps of:
(A) providing a container holding a predetermined amount of latex paint;
(B) providing a predetermined quantity of water-soluble pouches, wherein the predetermined quantity of water-soluble pouches is determined based on the predetermined amount of latex paint held in the container, each water-soluble pouch of the predetermined quantity of water-soluble pouches comprising:
a first sheet having an interior surface and an opposing exterior surface, the first sheet comprised of a first water-soluble material;
a second sheet having an interior surface and an opposing exterior surface, the second sheet comprised of a second water-soluble material, the first and second sheets being plastically deformed and at least partially joined together such that the interior surfaces of the first and second sheets cooperate to define at least one interior chamber; and
one or more pigments contained within the at least one interior chamber;
wherein:
the one or more pigments are selected from a group consisting of a primary blue pigment, a primary red pigment, a primary yellow pigment, a black pigment, a white pigment and combinations thereof, and
the first and second sheets are at least partially joined together by way of a bonding process;
the method further comprising the steps of:
(C) providing a mixing device;
(D) inserting the predetermined quantity of water-soluble pouches into the predetermined amount of latex paint held in the container; and
(E) operating the mixing device to mix the predetermined quantity of water-soluble pouches with the predetermined amount of latex paint held in the container for at least a predetermined period of time.
